(19) United States
(12) Patent Application Publication
(10) Pub. No.: US 2001/0054040 A1
(43) Pub. Date: Dec. 20, 2001

(54) System and method for searching a web site having an English-based domain name mapped to another language-based domain name

(76) Inventor: Soo Sung Lee, Seoul (KR)

Correspondence Address: STAAS & HALSEY LLP, 700 11TH STREET, NW, SUITE 500, WASHINGTON, DC, 20001, US

(21) Appl. No.: 09/767,908

(22) Filed: Jan. 24, 2001

(30) Foreign Application Priority Data
Jun. 20, 2000 (KR) 2000-33914
Oct. 17, 2000 (KR) 2000-60998
Jan. 17, 2001 (KR) 2001-2689

(51) Int. Cl. G06F 7/00

(52) U.S. Cl. 707/4

(57) ABSTRACT

A system for searching a target Web site, includes: an Internet network; a client computer, coupled to the Internet network, for displaying at least one target Web page contained in the target Web site; an intermediate server computer, coupled to the Internet network, for providing at least one intermediate Web page to the client computer, the intermediate Web page including: an input box having a first or second language-based domain name inputted by a user at the client computer; a first keyboard conversion icon being clicked in order to convert a keyboard into a first language-based keyboard, the keyboard being attached to said client computer; a second keyboard conversion icon being clicked in order to convert the keyboard into a second language-based keyboard; and a search icon being clicked in order to search the target Web site having the first language-based domain name mapped to the second language-based domain name; and a target server computer, coupled to the Internet network, for providing the target Web page targeted by the client computer. Therefore, the system can effectively and simply access the target Web site or the target Web page contained in the target Web site.

### FIELD OF THE INVENTION

The present invention relates to the field of searching a World-Wide Web (hereinafter referred to as “Web”) site; and, more particularly, to a system and method for searching the Web site having an English-based domain name mapped to a native-based domain name or a third language-based domain name.

### DESCRIPTION OF THE PRIOR ART

Generally, a client computer, implemented as a personal computer (PC), can communicate with a server computer such as a contents provider (CP) or an information provider (IP) over a network, e.g., an Internet network. Therefore, the client computer can retrieve and download desired information from a Web site contained in a server computer by entering a set of key data, sent from a keyboard, as a domain name based on an English language. The domain name as a Web address is a unique name used to identify a specific Web site.

The Web site has a home page as an initial Web page and at least one Web page. Further, the client computer can subscribe to a PC communications service such as CHOLLIAN™ supplied by Dacom Corporation, UNITEL™ supplied by Unitel Co., Ltd., etc. After the client computer has subscribed to a PC communication service, the client computer can retrieve and download the desired information from the Web site contained in the server computer by employing a provision screen and service usage in the PC communication service.

In case that a user at the client computer installs a corresponding browser program contained in a compact disk (CD) and an icon capable of connecting the client computer to the server computer by one click, the client computer can retrieve and download the desired information from the Web site contained in the server computer connected to the client computer by one click.

Further, in case that the user at the client computer inputs the English-based domain name into an address input box displayed on an MSN™ Web site supplied by Microsoft Corporation or another Web site, the client computer can retrieve and download the desired information from the Web site having the English-based domain name inputted by the user.

As described above, only where the user at the client computer knows the English-based domain name corresponding to the Web site, the user can access the Web site or the Web page contained in the Web site. Accordingly, there is a problem that the client computer can not access the Web site or the Web page contained in the Web site if the user at the client computer does not know the English-based domain name corresponding to the Web site.

For the sake of providing an efficient Internet communication to the client computer, it is strongly needed that the server computer, which is capable of searching the Web site or the Web page having the English-based domain name mapped to a native-based domain name or a third language-based domain name.

### SUMMARY OF THE INVENTION

It is, therefore, an object of the present invention to provide a system and method for searching a Web site having an English-based domain name mapped to a native-based domain name or a third language-based domain name, which can effectively and simply access the Web site or a Web page contained in the Web site.

It is, therefore, another object of the present invention to provide a system and method for searching a Web site having an English-based domain name mapped to a native-based domain name or a third language-based domain name such as a Korean-based domain name, a Japanese-based domain name, a Chinese-based domain name, a German-based domain name, a French-based domain name, an Italian-based domain name, a Latin-based domain name, a Russian-based domain name, a Spanish-based domain name, an Arab-based domain name, a Portuguese-based domain name, a Dutch-based domain name or a Hindustani-based domain name.

It is, therefore, further another object of the present invention to provide a computer-readable medium storing program instructions, the program instructions disposed on a computer to perform a method for searching a Web site having an English-based domain name mapped to a native-based domain name or a third language-based domain name.

In accordance with a first aspect of the present invention, there is provided a system for searching a Web site, comprising: a server computer for providing at least one Web page to a client computer, the web page including: an input box having a first or second language-based domain name inputted by a user at said client computer; a first keyboard conversion icon being clicked in order to convert a keyboard into a first language-based keyboard, the keyboard being attached to said client computer; a second keyboard conversion icon being clicked in order to convert the keyboard into a second language-based keyboard; and a search icon being clicked in order to search the Web site having the first language-based domain name mapped to the second language-based domain name.

In accordance with a second aspect of the present invention, there is provided a system for searching a target Web site, comprising: an Internet network; a client computer, coupled to said Internet network, for displaying at least one target Web page contained in the target Web site; an intermediate server computer, coupled to said Internet network, for providing at least one intermediate Web page to said client computer, the intermediate Web page including: an input box having a first or second language-based domain name inputted by a user at said client computer; a first keyboard conversion icon being clicked in order to convert a keyboard into a first language-based keyboard, the keyboard being attached to said client computer; a second keyboard conversion icon being clicked in order to convert the keyboard into a second language-based keyboard; and a search icon being clicked in order to search the target Web site having the first language-based domain name mapped to the second language-based domain name; and a target server computer, coupled to said Internet network, for providing the target Web page targeted by said client computer.

In accordance with a third aspect of the present invention, there is provided a method for searching a target Web site, comprising the steps of: a) inputting a set of key data corresponding to a domain name, the domain name including a first language-based domain name and a second language-based domain name; b) identifying the first language-based domain name mapped to the second language-based domain name from a mapping table; and c) searching the target Web site having the first language-based domain name identified from the mapping table.

In accordance with a fourth aspect of the present invention, there is provided a computer-readable medium storing program instructions, the program instructions disposed on a computer to perform a method for searching a target Web site, the method comprising the steps of: a) inputting a set of key data corresponding to a domain name, the domain name including a first language-based domain name and a second language-based domain name; b) identifying the first language-based domain name mapped to the second language-based domain name from a mapping table; and c) searching the target Web site having the first language-based domain name identified from the mapping table.

### BRIEF DESCRIPTION OF THE DRAWINGS

The above and other objects and features of the instant invention will become apparent from the following description of preferred embodiments taken in conjunction with the accompanying drawings, in which:

FIG. 1 is an exemplary block diagram illustrating a system for searching a target Web site having an English-based domain name mapped to a native-based domain name or a third language-based domain name in accordance with an embodiment of the present invention;

FIG. 2 depicts a first exemplary display screen representing a Web page sent from an intermediate server computer to a client computer contained in the system shown in FIG. 1;

FIG. 3 describes an exemplary mapping table stored in a database of an intermediate server computer shown in FIG. 1;

FIGS. 4A and 4B are exemplary flowcharts showing a method for searching a target Web site having an English-based domain name mapped to a Korean-based domain name as a native-based domain name by employing a first exemplary display screen shown in FIG. 2;

FIG. 5 is a second exemplary display screen representing a Web page sent from an intermediate server computer to a client computer shown in FIG. 1;

FIGS. 6A to 6C are exemplary flowcharts illustrating a method for searching a target Web site having an English-based domain name mapped to a native-based domain name or a third language-based domain name by employing a second exemplary display screen shown in FIG. 5;

FIG. 7 depicts a third exemplary display screen representing a Web page sent from an intermediate server computer to a client computer contained in the system shown in FIG. 1;

FIG. 8 depicts a fourth exemplary display screen representing a Web page sent from an intermediate server computer to a client computer contained in the system shown in FIG. 1;

FIGS. 9A and 9B are exemplary flowcharts illustrating a method for searching a target Web site by employing a fourth exemplary display screen shown in FIG. 8;

FIG. 10 is a fifth exemplary display screen representing a Web page sent from an intermediate server computer to a client computer contained in the system shown in FIG. 1; and

FIGS. 11A and 11B are exemplary flowcharts illustrating a method for searching a target Web site by employing a fifth exemplary display screen shown in FIG. 10.

### DETAILED DESCRIPTION OF THE INVENTION

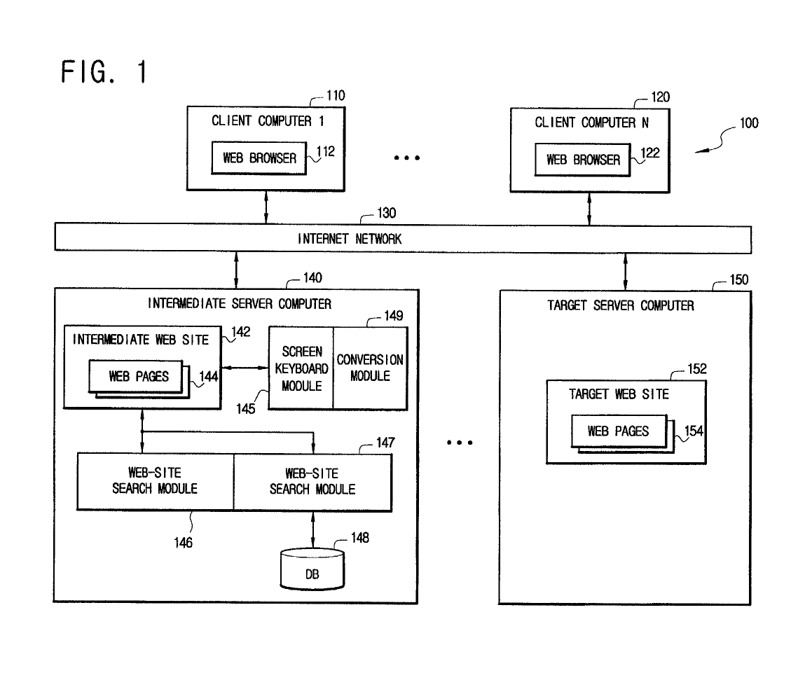

Referring to FIG. 1, there is shown an exemplary block diagram illustrating a system for searching a target Web site having an English-based domain name mapped to a native-based domain name or a third language-based domain name in accordance with an embodiment of the present invention. As shown, a system 100 includes client computers 110 and 120, an Internet network 130, an intermediate server computer 140 and a target server computer 150. The client computers 110 and 120 have Web browsers 112 and 122 as software applications to search a target Web site 152 contained in the target server computer 150 over the Internet network 130 having a common communication line, respectively. The client computers 110 and 120 can be coupled to the intermediate server computer 140 by employing the Web browsers 112 and 122, respectively. In other words, a user at the client computer 110 or 120 can connect the client computer 110 or 120 to the intermediate server computer 140 by clicking an icon corresponding to the Web browser 112 or 122, wherein the icon is displayed on a display screen (not shown).

The intermediate server computer 140 includes an intermediate Web site 142, a screen keyboard module 145, Web-site search modules 146 and 147, a database (DB) 148 and a conversion module 149. The intermediate Web site 142 is made up of a plurality of Web pages 144 having a home page as an initial Web page and other Web pages. For example, the intermediate Web site 142 has the English-based domain name of “http://www.speed007.net”. The intermediate Web site 142 is coupled to the screen keyboard module 145 and the Web-site search modules 146 and 147.

The intermediate server computer 140 searches the target server computer 150 or a target Web site 152 contained in the target server computer 150, wherein the target Web site 152 has the English-based domain name. Particularly, the intermediate sever computer 140 can search the target Web site 152 having the English-based domain name mapped to a Korean-based domain name, which is inputted by the user at the client computer 110 or 120.

After the client computer 110 or 120 has been connected to the intermediate server computer 140, the intermediate server computer 140 provides the home page as the initial Web page to the client computer 110 or 120. The screen keyboard module 145, coupled to the conversion module 149, provides a screen keyboard, which includes a set of screen keys based on a third language, e.g., a Japanese language, a Chinese language, a German language, a French language, an Italian language, a Latin language, a Russian language, a Spanish language, an Arab language, a Portuguese language, a Dutch language or a Hindustani language. The conversion module 149 converts the screen keyboard based on a language to another screen keyboard based on another language depending upon a user's language selection. The screen keyboard module 145 enables the user to input an input data representing a third language-based domain name by allowing the user to click a set of screen keys corresponding to the third language-based domain name. Further, the conversion module 149 is coupled to a keyboard (not shown), which is attached to the client computer 110 or 120. The conversion module 149 converts the keyboard into the keyboard based on a language or another language depending upon a cursor position.

Conventionally, the Web-site search module 146 searches the target Web site having the English-based domain name as well known to those skilled in the art. The Web-site search module 146 connects the client computer 110 or 120 to the Web page contained in the target Web site 152. The Web-site search module 147, coupled to the DB 148, searches the target Web site 152 having the English-based domain name mapped to the Korean-based domain name as the native-based domain name. The DB 148 stores a mapping table, which is made up of English-based domain names and native-based domain names, e.g., Korean-based domain names. The DB 148 can further store third language-based domain names, e.g., Japanese-based domain names, Chinese-based domain names, German-based domain names, French-based domain names, Italian-based domain names, Latin-based domain names, Russian-based domain names, Spanish-based domain names, Arab-based domain names, Portuguese-based domain names, Dutch-based domain names or Hindustani-based domain names. Alternatively, the Web-site search module 147 can search the target Web site 152 having the English-based domain name mapped to the third language-based domain name, which is inputted via the screen keyboard. Furthermore, the DB 148 can store class information and keywords related to the class information, wherein each of the keywords is mapped to the English-based domain name.

Where the user at the client computer 110 or 120 inputs an input data relating to the native-based domain name, e.g., the Korean-based domain name, into the Web page 144, the Web-site search module 147 employs the DB 148 to identify the English-based domain name mapped to the native-based domain name. Then, the Web-site search module 147 searches the target Web site 152 having the English-based domain name identified from the DB 148. After the Web-site search module 147 has searched the target Web site 152, the Web-site search module 147 connects the client computer 110 or 120 to the Web page 154 contained in the target Web site 152. At this time, a computer monitor (not shown) of the client computer 110 or 120 displays the Web page 154. Accordingly, the user at the client computer 110 or 120 can retrieve and download desired information from the target Web site 152 via the intermediate server computer 140.

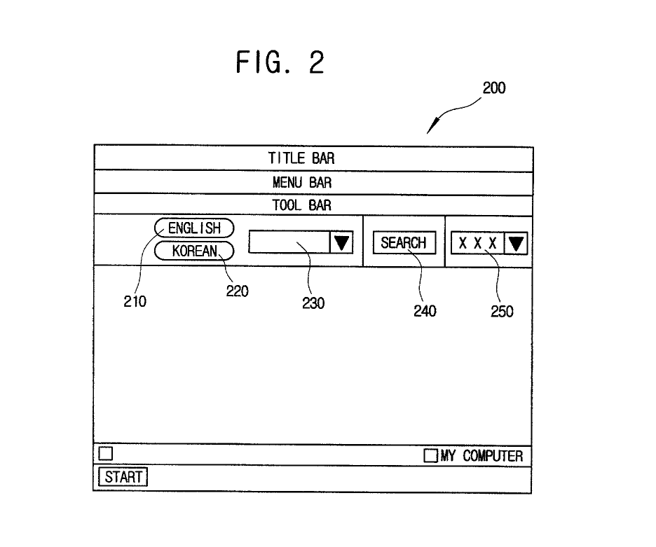

Referring to FIG. 2, there is shown a first exemplary display screen representing a Web page sent from an intermediate server computer to a client computer contained in the system shown in FIG. 1. As shown in FIG. 2, a display screen 200 includes keyboard conversion icons 210 and 220, an input box 230, a search icon 240 and a designation box 250. The user at the client computer 110 or 120 shown in FIG. 1 can input a set of key data corresponding to a domain name or a keyword into the input box 230 via a keyboard (not shown) attached to the client computer 110 or 120. The set of key data is based on either an English language or a Korean language. If an arrow at the designation box 250 is clicked by the user, the designation box 250 displays a list of classes, wherein the list of classes includes a domain name, a business corporation name, a firm name, a company name, a trademark name, a product name, a private person name, a musician name, an entertainer name, a sportsman name, an artist name, a churchman name, a politician name, a businessman name, a celebrity name, a lawyer name, a school name, a state organization name, a non-profit organization name, an institute name, a network manager name, etc. The user can designate one of the classes corresponding to the set of key data from the designation box 250.

If the user clicks the keyboard conversion icon 210 for the English language, the conversion module 149 shown in FIG. 1 converts the keyboard into an English-based keyboard. Simultaneously, a color of the keyboard conversion icon 210 is varied. Hereinafter, the user can input an English-based domain name or an English keyword into the input box 230 through the English-based keyboard. Otherwise, if the user clicks the keyboard conversion icon 220 for the Korean language, the conversion module 149 converts the keyboard into a Korean-based keyboard. Simultaneously, the color of the keyboard conversion icon 220 is varied. Hereinafter, the user can input a Korean-based domain name or a Korean keyword into the input box 230 through the Korean-based keyboard.

If the English-based domain name is inputted into the input box 230, the search icon 240 enables the Web-site search module 146 shown in FIG. 1 to search the target Web site 152 having the English-based domain name. Otherwise, if the Korean-based domain name or the English or Korean keyword is inputted into the input box 230, the search icon 240 enables the Web-site search module 147 shown in FIG. 1 to search the target Web site 152 having the English-based domain name mapped to the Korean-based domain name, or the English or Korean keyword.

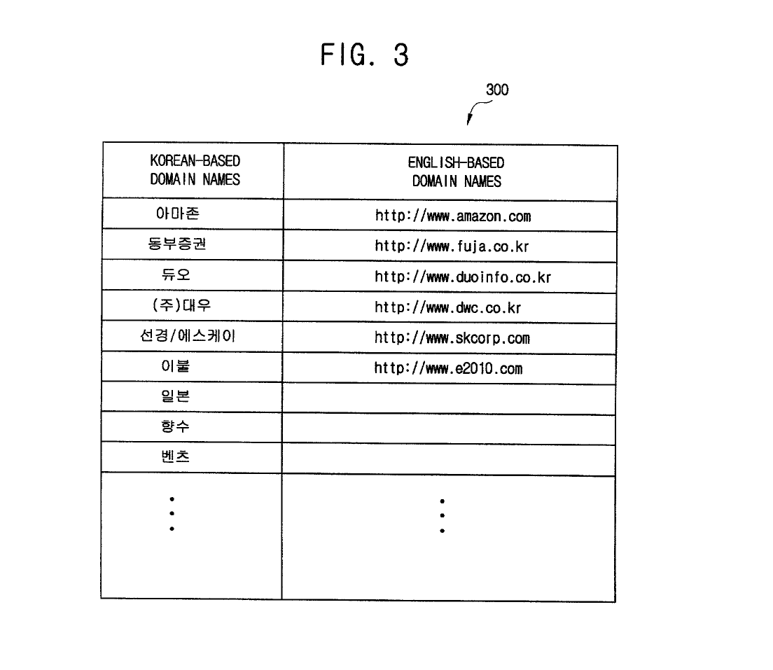

Referring to FIG. 3, there is described an exemplary mapping table contained in a database, wherein the database is constructed in an intermediate server computer shown in FIG. 1. As shown, a mapping table 300 includes Korean-based domain names and English-based domain names, wherein each of the Korean-based domain names is mapped to a corresponding English-based domain name. The mapping table 300 can further include third language-based domain names (not shown), wherein each of the third language-based domain names is mapped to the corresponding English-based domain name. Furthermore, the mapping table 300 can include English keywords, Korean keywords and third language keywords, wherein each of the English, Korean or third language keywords is mapped to the corresponding English-based domain name.

Where the search icon 240 shown in FIG. 2 is clicked by the user at the client computer 110 or 120 shown in FIG. 1, the Web-site search module 147 shown in FIG. 1 identifies an English-based domain name, mapped to a Korean-based domain name or a third language-based domain name, from the mapping table 300. Further, where the search icon 240 is clicked by the user, the Web-site search module 147 identifies the English-based domain name, mapped to an English, Korean or third language keyword, from the mapping table 300. Then, the Web-site search module 147 searches the target Web site 152 having the English-based domain name identified in the mapping table 300.

Still furthermore, the mapping table 300 can include class information related to the English, Korean and third language keywords. The class information includes a domain name, a business corporation name, a firm name, a company name, a trademark name, a product name, a private person name, a musician name, an entertainer name, a sportsman name, an artist name, a churchman name, a politician name, a businessman name, a celebrity name, a lawyer name, a school name, a state organization name, a non-profit organization name, an institute name, a network manager name, etc.

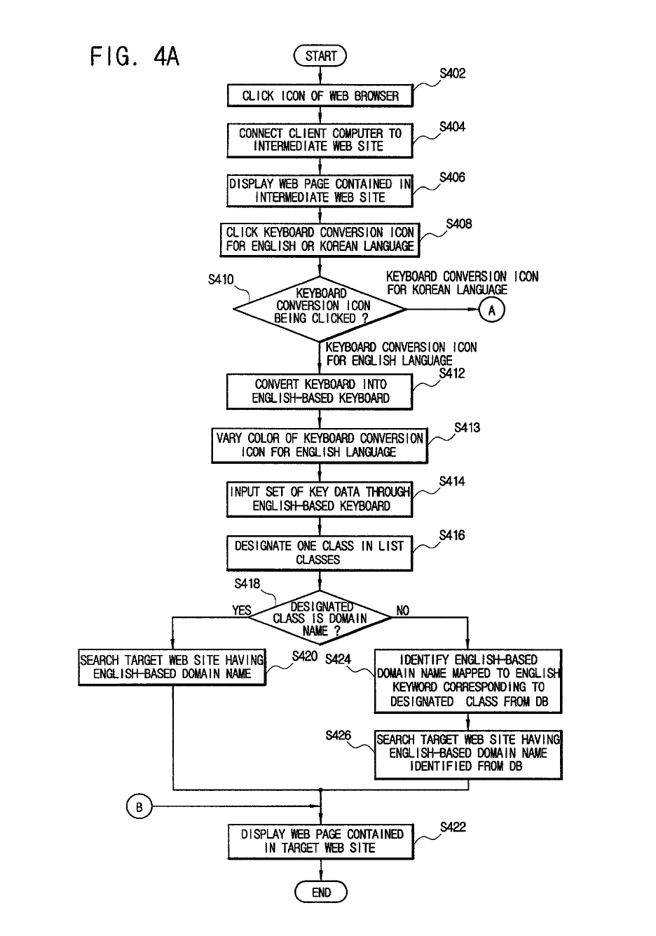

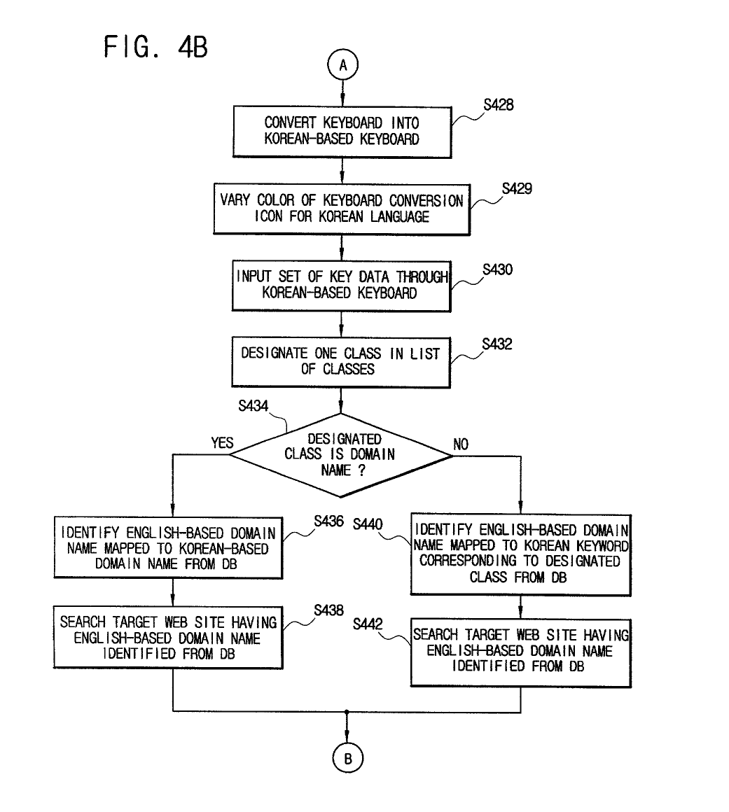

Referring to FIGS. 4A and 4B, there are exemplary flowcharts showing a method for searching a target Web site having an English-based domain name mapped to a Korean-based domain name as a native-based domain name by employing a first exemplary display screen shown in FIG. 2. As shown in FIG. 4A, the user at the client computer 110 or 120 shown in FIG. 1 clicks, at step S402, an icon of the Web browser 112 or 122 displayed on a computer monitor of the client computer 110 or 120. Then, the Web browser 112 or 122 connects, at step S404, the client computer 110 or 120 to the intermediate Web site 142 contained in the intermediate server computer 140 over the Internet network 130. Then, the computer monitor of the client computer 110 or 120 displays, at step S406, the display screen 200 as a Web page 144 contained in the intermediate Web site 142.

Hereinafter, the user clicks, at step S408, a keyboard conversion icon 210 or 220 for an English or Korean language shown in FIG. 2. Then, at step S410, it is determined whether any keyboard conversion icon is clicked by the user. If the keyboard conversion icon 210 for the English language is clicked by the user, the conversion module 149 shown in FIG. 1 converts, at step S412, a keyboard attached to the client computer 110 or 120 into an English-based keyboard. Then, a color of the keyboard conversion icon 210 for the English language is varied at step S413. Then, the user inputs, at step S414, a set of key data into the input box 230 shown in FIG. 2 through the English-based keyboard. Then, the user designates, at step S416, one class in a list of classes through the designation box 250 shown in FIG. 2, wherein the list of classes includes a domain name, a business corporation name, a firm name, a company name, a trademark name, a product name, a private person name, a musician name, an entertainer name, a sportsman name, an artist name, a churchman name, a politician name, a businessman name, a celebrity name, a lawyer name, a school name, a state organization name, a non-profit organization name, an institute name, a network manager name, etc. Then, at step S418, it is determined whether the designated class is the domain name. If the designated class is the domain name, the Web-site search module 146 searches, at step S420, the target Web site 152 having the English-based domain name representing the set of key data. Then, the computer monitor of the client computer 110 or 120 displays, at step S422, the Web page 154 contained in the target Web site 152. Otherwise, if the designated class is not the domain name, the Web-site search module 147 identifies, at step S424, the English-based domain name mapped to an English keyword corresponding to the designated class from the DB 148 shown in FIG. 1, wherein the English keyword represents the set of key data. Then, the Web-site search module 147 searches, at step S426, the target Web site 152 having the English-based domain name identified from the DB 148. Then, the computer monitor of the client computer 110 or 120 displays, at step S422, the Web page 154 contained in the target Web site 152.

As shown in FIG. 4B, if the keyboard conversion icon 220 for the Korean language is clicked by the user, the conversion module 149 converts, at step S428, the keyboard into a Korean-based keyboard. Then, the color of the keyboard conversion icon 220 for the Korean language is varied at step S429. Then, the user inputs, at step S430, the set of input data into the input box 230 through the Korean-based keyboard. Then, the user designates, at step S432, one class in the list of classes through the designation box 250. Then, at step S434, it is determined whether the designated class is the domain name. If the designated class is the domain name, the Web-site search module 147 identifies, at step S436, the English-based domain name mapped to the Korean-based domain name representing the set of key data from the DB 148. Then, the Web-site search module 147 searches, at step S438, the target Web site having the English-based domain name identified from the DB 148. Then, the computer monitor of the client computer 110 or 120 displays, at step S422, the Web page 154 contained in the target Web site 152. Otherwise, if the designated class is not the domain name, the Web-site search module 147 identifies, at step S440, the English-based domain name mapped to a Korean keyword corresponding to the designated class from the DB 148, wherein the Korean keyword represents the set of key data. Then, the Web-site search module 147 searches, at step S442, the target Web site 152 having the English-based domain name identified from the DB 148. Then, the computer monitor of the client computer 110 or 120 displays, at step S422, the Web page 154 contained in the target Web site 152.

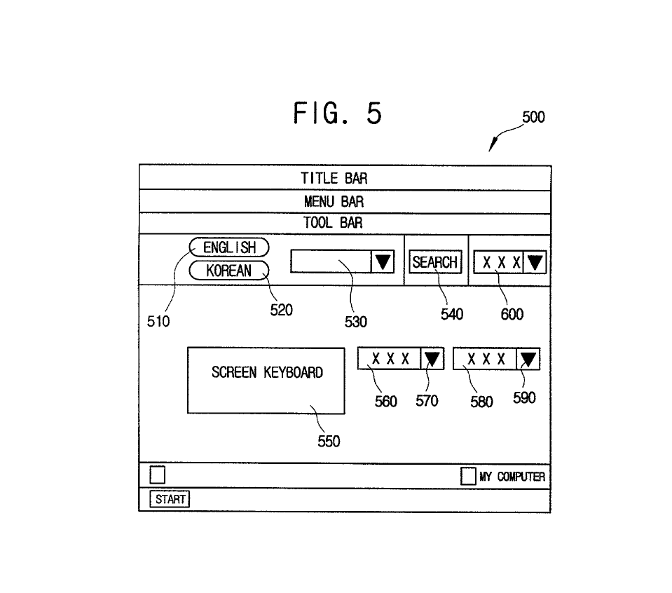

Referring to FIG. 5, there is shown a second exemplary display screen representing a Web page sent from an intermediate server computer to a client computer shown in FIG. 1. As shown, a display screen 500 includes keyboard conversion icons 510 and 520, an input box 530, a search icon 540, a screen keyboard 550, designation boxes 560, 580 and 600, and arrows 570 and 590. A functionality of the screen keyboard 550, which is displayed on the Web page 144 shown in FIG. 1, is the same as that of a keyboard (not shown), wherein the keyboard as an input device is attached to a main body of the client computer 110 or 120 shown in FIG. 1. The screen keyboard 550 includes a plurality of screen keys, wherein the screen keys are based on various languages. For example, the screen keys are based on an English language, a Korean language, a Japanese language, a Chinese language, a German language, a French language, an Italian language, a Latin language, a Russian language, a Spanish language, an Arab language, a Portuguese language, a Dutch language or a Hindustani language.

If the user at the client computer 110 or 120 clicks the arrow 570, a list of languages is displayed on the display screen 500. Then, if the user designates one language in the list of languages, a name of the designated language is inputted into the designation box 560. The designation box 560 displays the name of the designated language. Then, the screen keyboard 550 relating to the designated language is displayed on the display screen 500. When the user selects a set of screen key data corresponding to a designated language-based domain name or a designated language-based keyword from the screen keys of the screen keyboard 550, the set of screen key data is inputted into the input box 530. At this time, the Web-site search module 147 identifies the English-based domain name mapped to the designated language-based domain name or the designated language-based keyword from the DB 148. Then, the Web-site search module 147 searches the target Web site 152 having the English-based domain name identified from the DB 148.

If the user at the client computer 110 or 120 clicks the arrow 590, a list of countries is displayed on the display screen 500. Then, if the user designates one country in the list of countries, a name of the designated country is inputted into the designation box 580. The designation box 580 displays the name of the designated country. Then, the Web-site search module 147 connects the client computer 110 or 120 to the target Web site 152 corresponding to the designated country.

The keyboard conversion icons 510 and 520 shown in FIG. 5 substantially have the same functionality as the keyboard conversion icons 210 and 220 shown in FIG. 2. Similarly, the search icon 540 and the designation box 600 shown in FIG. 5 substantially have the same functionality as the search icon 240 and the designation box 250 shown in FIG. 2.

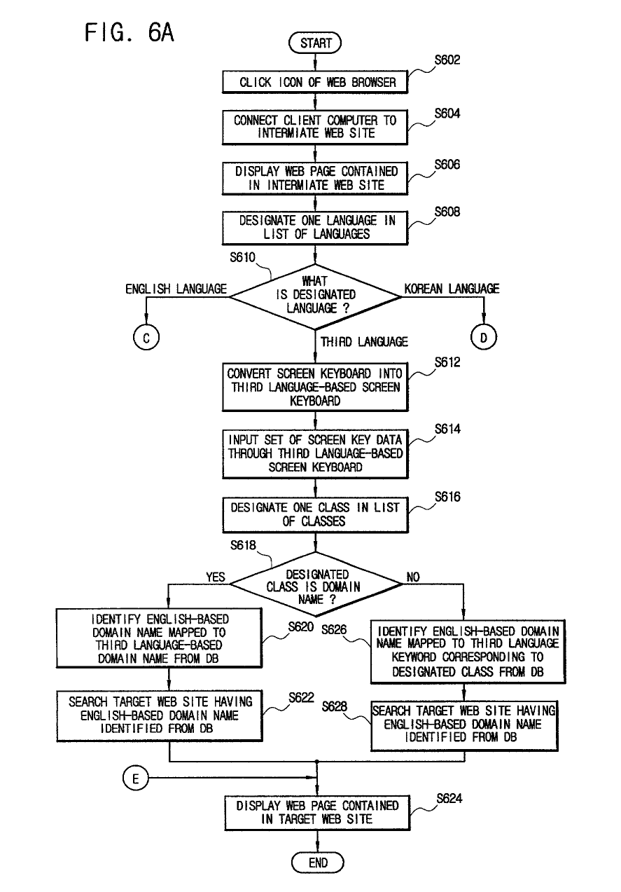

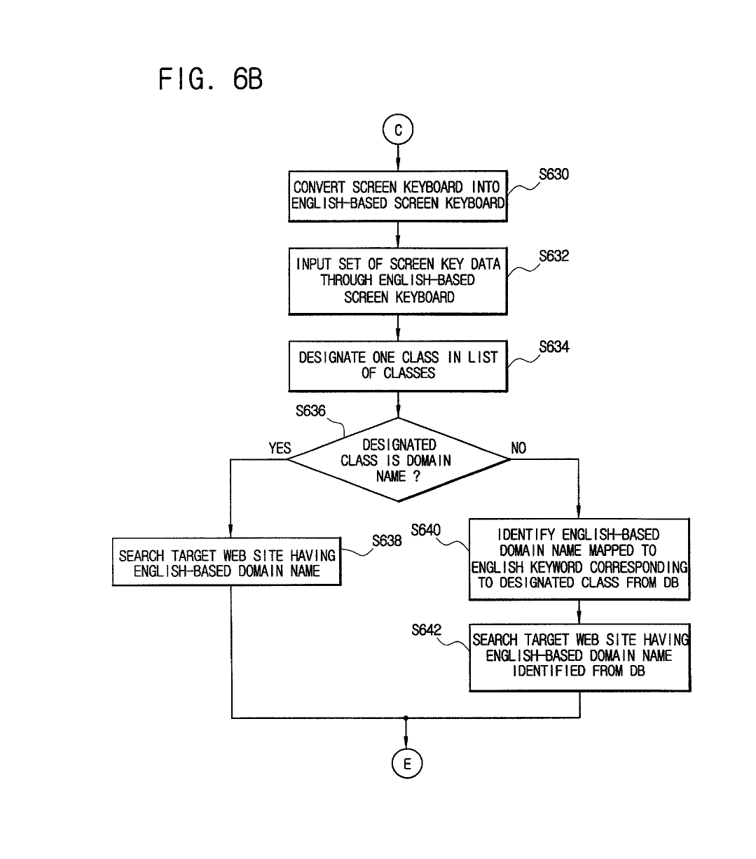

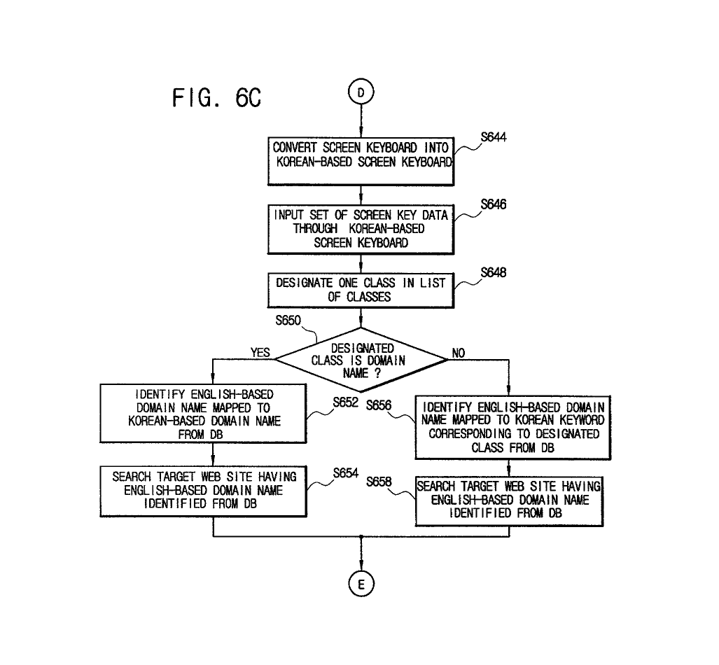

Referring to FIGS. 6A to 6C, there are shown exemplary flowcharts illustrating a method for searching a target Web site having an English-based domain name mapped to a native-based domain name or a third language-based domain name by employing a second exemplary display screen shown in FIG. 5. As shown in FIG. 6A, the user at the client computer 110 or 120 shown in FIG. 1 clicks, at step S602, an icon of the Web browser 112 or 122 displayed on a computer monitor of the client computer 110 or 120. Then, the Web browser 112 or 122 connects, at step S604, the client computer 110 or 120 to the intermediate Web site 142 contained in the intermediate server computer 140 over the Internet network 130. Then, the computer monitor of the client computer 110 or 120 displays, at step S606, the display screen 500 as a Web page 144 contained in the intermediate Web site 142.

Hereinafter, the user designates, at step S608, one language in a list of languages by employing the designation box 560. Then, at step S610, it is determined whether the designated language is an English language, a Korean language or a third language. If the designated language is the third language, the conversion module 149 converts, at step S612, the screen keyboard 550 into a third language-based screen keyboard. Then, the user inputs, at step S614, a set of screen key data through the third language-based screen keyboard. Then, the user designates, at step S616, one class in a list of classes through the designation box 600, wherein the list of classes includes a domain name, a business corporation name, a firm name, a company name, a trademark name, a product name, a private person name, a musician name, an entertainer name, a sportsman name, an artist name, a churchman name, a politician name, a businessman name, a celebrity name, a lawyer name, a school name, a state organization name, a non-profit organization name, an institute name, a network manager name, etc.

Hereinafter, at step S618, it is determined whether the designated class is the domain name. If the designated class is the domain name, the Web-site search module 147 shown in FIG. 1 identifies, at step S620, an English-based domain name mapped to a third language-based domain name from the DB 148 shown in FIG. 1. Then, the Web-site search module 147 searches, at step S622, the target Web site 152 having the English-based domain name identified from the DB 148. Then, the computer monitor of the client computer 110 or 120 displays, at step S624, a Web page 154 contained in the target Web site 152.

Otherwise, if the designated class is not the domain name, the Web-site search module 147 identifies, at step S626, the English-based domain name mapped to a third language keyword corresponding to the designated class from the DB 148. Then, the Web-site search module 147 searches, at step S628, the target Web site 152 having the English-based domain name identified from the DB 148. Then, the computer monitor of the client computer 110 or 120 displays, at step S624, the Web page 154 contained in the target Web site 152.

As shown in FIG. 6B, if the designated language is the English language, the conversion module 149 converts, at step S630, the screen keyboard 550 into an English-based screen keyboard. Then, the user inputs, at step S632, the set of screen key data through the English-based screen keyboard or a set of key data through an English-based keyboard. Then, the user designates, at step S634, one class in the list of classes through the designation box 600. Then, at step S636, it is determined whether the designated class is the domain name. If the designated class is the domain name, the Web-site search module 146 searches, at step S638, the target Web site having the English-based domain name. Then, the computer monitor of the client computer 110 or 120 displays, at step S624, the Web page 154 contained in the target Web site 152. Otherwise, if the designated class is not domain name, the Web-site search module 147 identifies, at step S640, the English-based domain name mapped to an English keyword corresponding to the designated class from the DB 148. Then, the Web-site search module 147 searches, at step S642, the target Web site 152 having the English-based domain name identified from the DB 148. Then, the computer monitor of the client computer 110 or 120 displays, at step S624, the Web page 154 contained in the target Web site 152.

As shown in FIG. 6C, if the designated language is the Korean language, the conversion module 149 converts, at step S644, the screen keyboard 550 into a Korean-based screen keyboard. Then, the user inputs, at step S646, the set of screen key data through the Korean-based screen keyboard or a set of key data through a Korean-based keyboard. Then, the user designates, at step S648, one class in the list of classes. Then, at step S650, it is determined whether the designated class is the domain name. If the designated class is the domain name, the Web-site search module 147 identifies, at step S652, the English-based domain name mapped to a Korean-based domain name from the DB 148. Then, the Web-site search module 147 searches, at step S654, the target Web site 152 having the English-based domain name identified from the DB 148. Then, the computer monitor of the client computer 110 or 120 displays, at step S624, the Web page 154 contained in the target Web site 152. Otherwise, if the designated class is not the domain name, the Web-site search module 147 identifies, at step S656, the English-based domain name mapped to a Korean keyword corresponding to the designated class from the DB 148. Then, the Web-site search module 147 searches, at step S658, the target Web site 152 having the English-based domain name identified from the DB 148. Then, the computer monitor of the client computer 110 or 120 displays, at step S624, the Web page 154 contained in the target Web site 152.

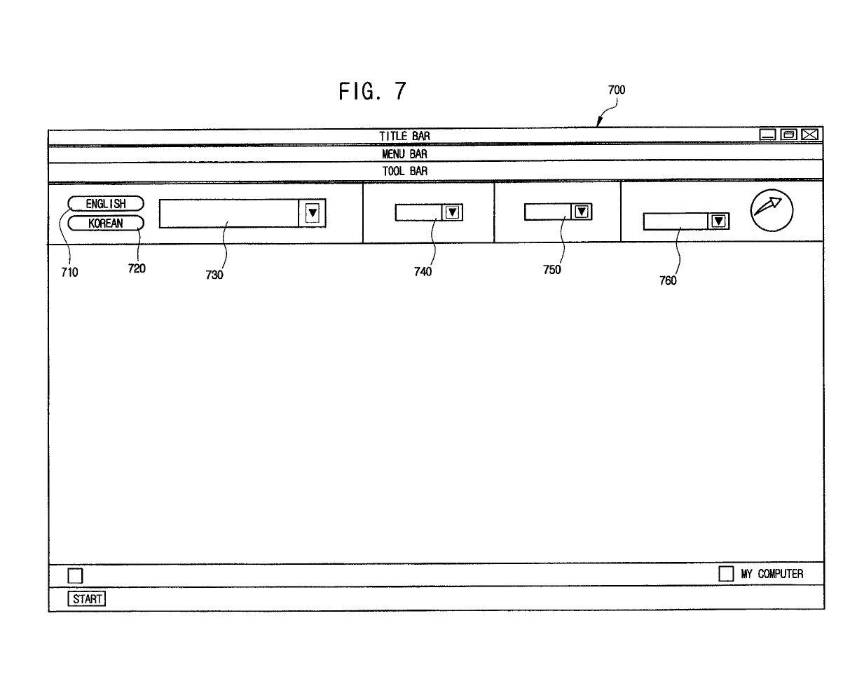

Referring to FIG. 7, there is shown a third exemplary display screen representing a Web page sent from an intermediate server computer to a client computer contained in the system shown in FIG. 1. As shown, a display screen 700 includes keyboard conversion icons 710 and 720, an input box 730, and designation boxes 740, 750 and 760. When the user clicks the keyboard conversion icon 710 for an English language and inputs the English-based domain name into the input box 730, the Web-site search module 146 searches the target Web site 152 having the English-based domain name. Further, when the user clicks the keyboard conversion icon 720 for a Korean language and inputs the Korean-based domain name into the input box 730, the Web-site search module 147 searches the target Web site 152 having the English-based domain name mapped to the Korean-based domain name.

The user can input an English keyword or a Korean keyword into the input box 730. Where the user clicks an arrow at the designation box 740 or 750, the designation box 740 or 750 displays a list of classes so that the user can designate a class corresponding to the English keyword or the Korean keyword in the list of classes. The list of classes includes a domain name, a business corporation name, a firm name, a company name, a trademark name, a product name, a private person name, a musician name, an entertainer name, a sportsman name, an artist name, a churchman name, a politician name, a businessman name, a celebrity name, a lawyer name, a school name, a state organization name, a non-profit organization name, an institute name, a network manager name, etc. Alternatively, the display screen 700 is fixed so that the designation boxes 740 and 750 can be corresponding to the Korean-based domain name or the Korean keyword, and the English-based domain name or the English keyword, respectively. The designation box 760 displays a list of sub-domain names corresponding to the English or Korean keyword. The list of sub-domain names includes “org”, “or”, “pe”, “ac”, “co. kr”, “co. jp”, “net”, “com”, etc.

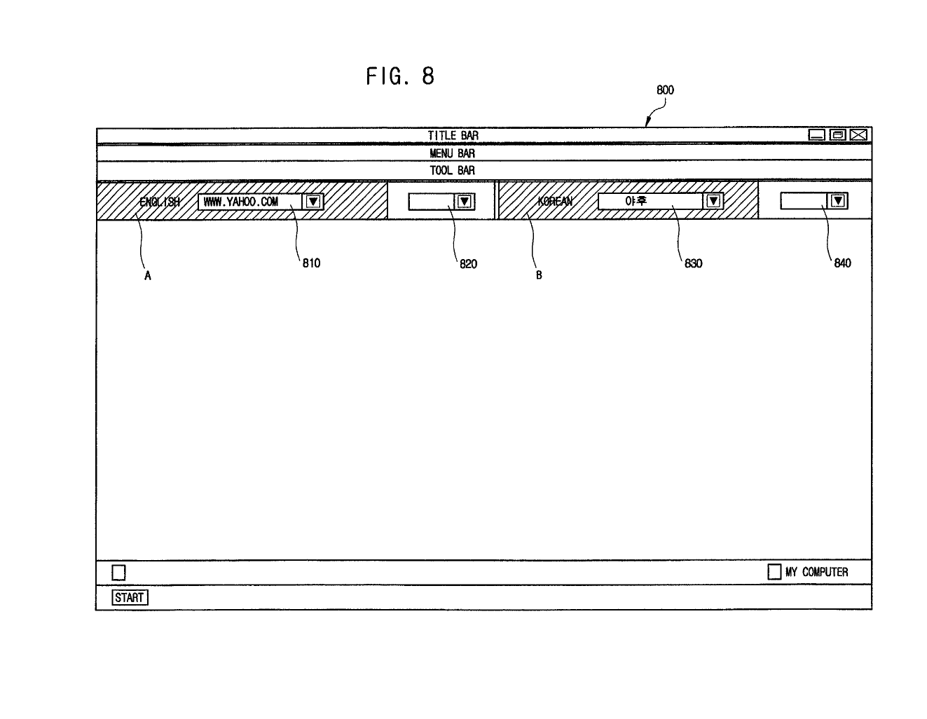

Referring to FIG. 8, there is shown a fourth exemplary display screen representing a Web page sent from an intermediate server computer to a client computer contained in the system shown in FIG. 1. As shown, a display screen 800 includes input boxes 810 and 830, and designation boxes 820 and 840. Where a user at the client computer 110 or 120 shown in FIG. 1 clicks an arrow at the designation box 820, the designation box 820 displays a list of classes so that the user can designate a class corresponding to an English-based domain name or an English keyword in the list of classes. The list of classes includes a domain name, a business corporation name, a firm name, a company name, a trademark name, a product name, a private person name, a musician name, an entertainer name, a sportsman name, an artist name, a churchman name, a politician name, a businessman name, a celebrity name, a lawyer name, a school name, a state organization name, a non-profit organization name, an institute name, a network manager name, etc. Further, the list of classes is based on an English language. The user can input the English-based domain name or the English keyword into the input box 810. If the user inputs the English-based domain name into the input box 810, the Web-site search module 146 searches the target Web site 152 having the English-based domain name. Otherwise, if the user inputs the English keyword into the input box 810, the Web-site search module 147 identifies the English-based domain name mapped to the English keyword corresponding to the designated class from the DB 148 shown in FIG. 1. Then the Web-site search module 147 searches the target Web site 152 having the English-based domain name identified from the DB 148.

Similarly, where the user at the client computer 110 or 120 clicks an arrow at the designation box 840, the designation box 840 displays the list of classes so that the user can designate the class corresponding to a Korean-based domain name or a Korean keyword in the list of classes. The user can input the Korean-based domain name or the Korean keyword into the input box 830. If the user inputs the Korean-based domain name into the input box 830, the Web-site search module 147 identifies the English-based domain name mapped to the Korean-based domain name from the DB 148 and then searches the target Web site 152 having the English-based domain name identified from the DB 148. Otherwise, if the user inputs the Korean keyword into the box 830, the Web-site search module 147 identifies the English-based domain name mapped to the Korean keyword corresponding to the designated class from the DB 148. Then, the Web-site search module 147 searches the target Web site 152 having the English-based domain name identified from the DB 148. As the user puts a cursor in the box 810 or 830 contained in the display screen 800, a color of a portion “A” is different from that of a portion “B”.

Conventionally, the keyboard, which is attached to the client computer 110 or 120, includes a language conversion key, e.g., an English-Korean conversion key or a Korean-English conversion key. Where the user presses the language conversion key while employing English-based keys, the English-based keys are converted into Korean-based keys. Similarly, Where the user presses the language conversion key while employing the Korean-based keys, the Korean-based keys are converted into the English-based keys.

Where the user puts the cursor into the input box 830 while the user is inputting the English-based domain name or the English keyword into the input box 810, the conversion module 149 shown in FIG. 1 automatically converts the English-based keys into the Korean-based keys. Accordingly, since the English-based keys are automatically converted into the Korean-based keys, the user can input the Korean-based domain name or the Korean keyword corresponding to the Korean-based keys without pressing the English-Korean conversion key contained in the keyboard.

Similarly, where the user puts the cursor into the input box 810 while the user is inputting the Korean-based domain name or the Korean keyword into the input box 830, the conversion module 149 shown in FIG. 1 automatically converts the Korean-based keys into the English-based keys. Accordingly, since the Korean-based keys are automatically converted into the English-based keys, the user can input the English-based domain name or the English keyword corresponding to the English-based keys without pressing the Korean-English conversion key contained in the keyboard.

Further, the user can search the English-based domain name and the business corporation, firm or company name registered in the DB 148 and based on the English language. Furthermore, the user can search the Korean-based domain name and the business corporation, firm or company name registered in the DB 148 and based on the Korean language.

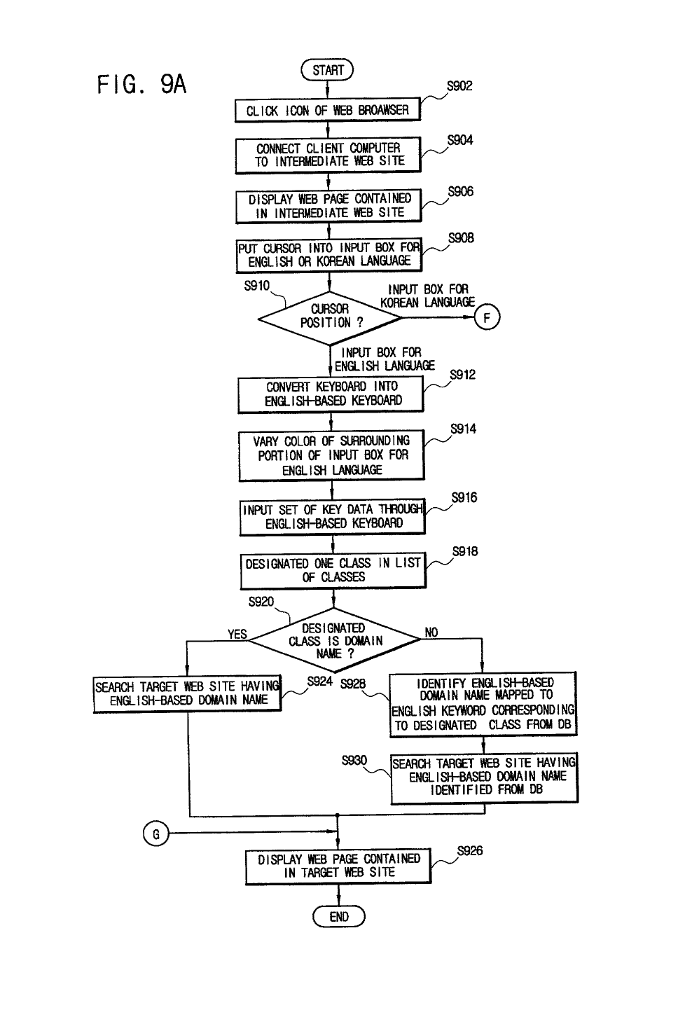

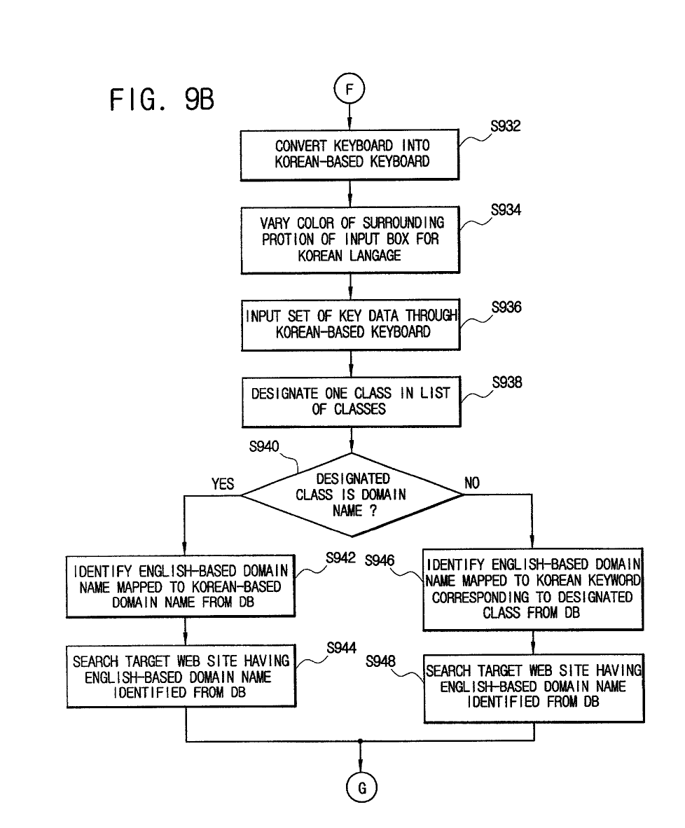

Referring to FIGS. 9A and 9B, there are shown exemplary flowcharts illustrating a method for searching a target Web site by employing a fourth exemplary display screen shown in FIG. 8. As shown in FIG. 9A, the user at the client computer 110 or 120 shown in FIG. 1 clicks, at step S902, an icon of the Web browser 112 or 122 displayed on a computer monitor of the client computer 110 or 120. Then, the Web browser 112 or 122 connects, at step S904, the client computer 110 or 120 to the intermediate Web site 142 contained in the intermediate server computer 140 over the Internet network 130. Then, the computer monitor of the client computer 110 or 120 displays, at step S906, the display screen 800 as a Web page 144 contained in the intermediate Web site 142.

Hereinafter, the user puts, at step S908, a cursor into the input box 810 or 830 for an English or Korean language shown in FIG. 8. Then, at step S910, it is determined whether the cursor is put into any input box. If the cursor is put into the input box 810, the conversion module 149 shown in FIG. 1 converts, at step S912, the keyboard attached to the client computer 110 or 120 into an English-based keyboard. Then, a color of a surrounding portion of the input box 810 for the English language is varied at step S914. Then, the user inputs, at step S916, a set of key data through the English-based keyboard.

Hereinafter, the user designates, at step S918, one class in a list of classes through the designation box 820. Then, at step S920, it is determined whether the designated class is a domain name. If the designated class is the domain name, the Web-site search module 146 searches, at step S924, the target Web site 152 having the English-based domain name. Then, the computer monitor of the client computer 110 or 120 displays, at step S926, the Web page 154 contained in the target Web site 152. Otherwise, if the designated class is not the domain name, the Web-site search module 147 identifies, at step S928, the English-based domain name mapped to an English keyword corresponding to the designated class from the DB 148 shown in FIG. 1. Then, the Web-site search module 147 searches, at step S930, the target Web site 152 having the English-based domain name identified from the DB 148. Then, the computer monitor of the client computer 110 or 120 displays, at step S926, the Web page 154 contained in the target Web site 152.

As shown in FIG. 9B, if the cursor is put into the input box 830 for the Korean language, the conversion module 149 converts, at step S932, the keyboard into a Korean-based keyboard. Then, a color of a surrounding portion of the input box 830 for the Korean language is varied at step S934. Then, the user inputs, at step S936, a set of key data through the Korean-based keyboard. Then, the user designates, at step S938, one class in a list of classes through the designation box 840. Then, at step S940, it is determined whether the designated class is the domain name. If the designated class is the domain name, the Web-site search module 147 identifies, at step S942, the English-based domain name mapped to a Korean-based domain name from the DB 148. Then, the Web-site search module 147 searches, at step S944, the target Web site 152 having the English-based domain name identified from the DB 148. Then, the computer monitor of the client computer 110 or 120 displays, at step S926, the Web page 154 contained in the target Web site 152.

Otherwise, if the designated class is not the domain name, the Web-site search module 147 identifies, at step S946, the English-based domain name mapped to a Korean keyword corresponding to the designated class from the DB 148. Then, the Web-site search module 147 searches, at step S948, searches the target Web site 152 having the English-based domain name identified from the DB 148. Then, the computer monitor of the client computer 110 or 120 displays, at step S926, the Web page 154 contained in the target Web site 152.

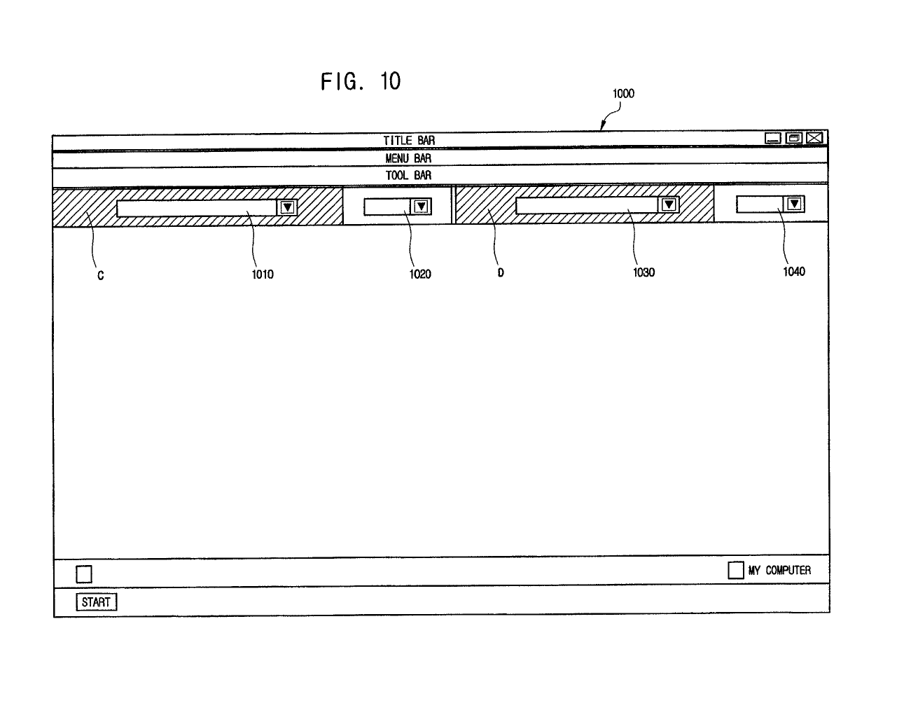

Referring to FIG. 10, there is shown a fifth exemplary display screen representing a Web page sent from an intermediate server computer to a client computer contained in the system shown in FIG. 1. As shown, a display screen 1000 includes input boxes 1010 and 1030, and designation boxes 1020 and 1040. Where a user at the client computer 110 or 120 shown in FIG. 1 clicks an arrow at the box 1020 or 1040, the designation box 1020 or 1040 displays a list of classes. Then, the user can designate one class in the list of classes. The list of classes includes a domain name, a business corporation name, a firm name, a company name, a trademark name, a product name, a private person name, a musician name, an entertainer name, a sportsman name, an artist name, a churchman name, a politician name, a businessman name, a celebrity name, a lawyer name, a school name, a state organization name, a non-profit organization name, an institute name, a network manager name, etc. The user can input an English-based domain name or an English keyword into the input box 1010 or 1030. If the user inputs the English-based domain name into the input box 1010 or 1030, the Web-site search module 146 searches the target Web site 152 having the English-based domain name. Otherwise, if the user inputs the English keyword into the input box 1010 or 1030, the Web-site search module 147 identifies the English-based domain name mapped to the English keyword and then searches the target Web site 152 having the English-based domain name identified from the DB 148. Alternatively, the display screen 1000 is fixed so that only the English-based domain name can be inputted into the input box 1010. As the user puts a cursor into the input box 1010 or 1030 contained in the display screen 1000, a color of a portion “C” becomes different from that of a portion “D”.

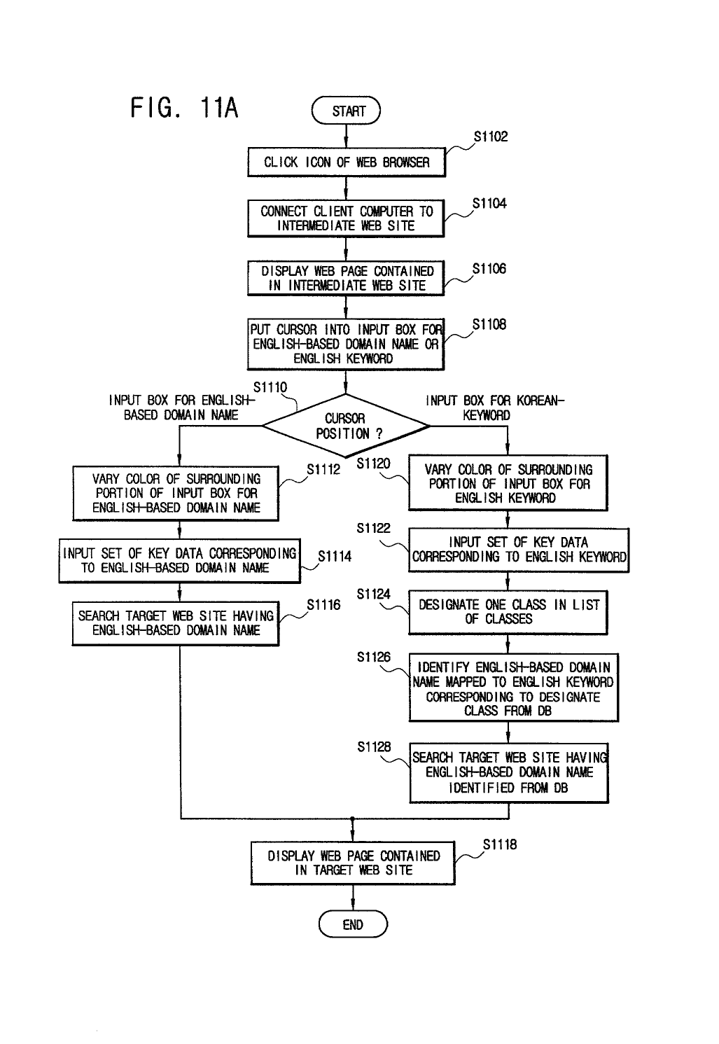

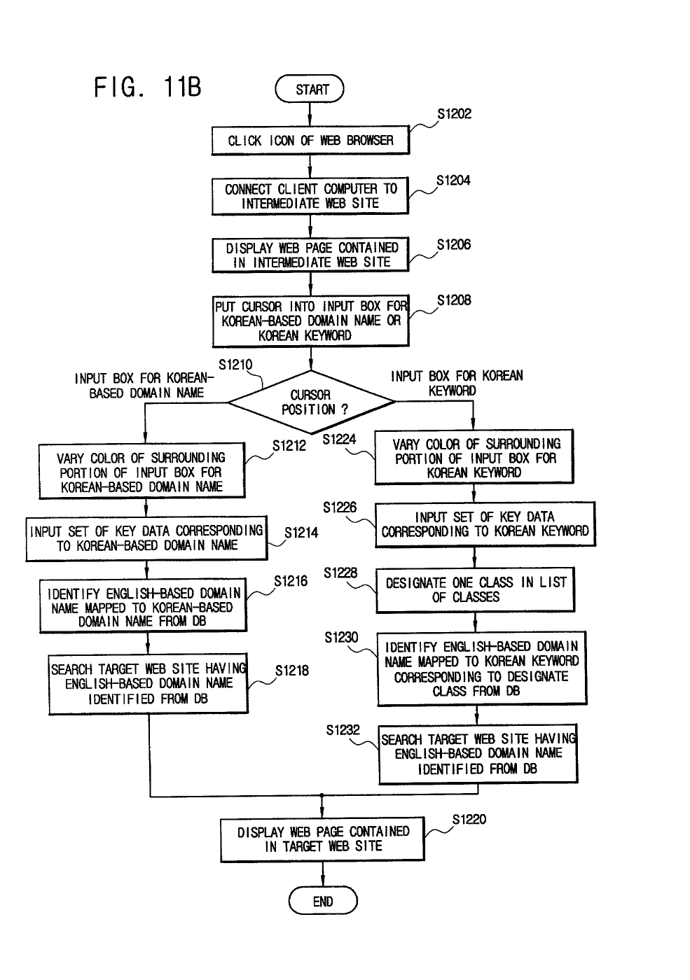

Referring to FIGS. 11A and 11B, there are shown exemplary flowcharts illustrating a method for searching a target Web site by employing a fifth exemplary display screen shown in FIG. 10. As shown in FIG. 11A, the user at the client computer 110 or 120 clicks, at step S1102, an icon of the Web browser 112 or 122 displayed on a computer monitor of the client computer 110 or 120. Then, the Web browser 112 or 122 connects, at step S1104, the client computer 110 or 120 to the intermediate Web site 142 contained in the intermediate server computer 140 over the Internet network 130. Then, the computer monitor of the client computer 110 or 120 displays, at step S1106, the display screen 1000 as a Web page 144 contained in the intermediate Web site 142.

Hereinafter, the user puts, at step S1108, a cursor into an input box for the English-based domain name or an English keyword. Then, at step S1110, it is determined whether the cursor is put into any input box. Then, if the cursor is put into the input box for the English-based domain name, a color of a surrounding portion of the input box for the English-based domain name is varied at step S1112. Then, the user inputs, at step S1114, a set of key data corresponding to the English-based domain name into the input box for the English-based domain name. Then, the Web-site search module 146 searches, at step S1116, the target Web site 152 having the English-based domain name. Then, the computer monitor of the client computer 110 or 120 displays, at step S1118, a Web page 154 contained in the target Web site 152.

Otherwise, if the cursor is put into the input box for the English keyword, a color of the input box for the English keyword is varied at step S1120. Then, the user inputs, at step S1122, a set of key data corresponding to the English keyword into the input box for the English keyword. Then, the user designates, at step S1124 one class in a list of classes through a designation box. Then, the Web-site search module 147 shown in FIG. 1 identifies, at step S1126, the English-based domain name mapped to the English keyword corresponding to the designated class from the DB 148 shown in FIG. 1. Then, the Web-site search module 147 searches, at step S1128, a target Web site 152 having the English-based domain name identified from the DB 148. Then, the computer monitor of the client computer 110 or 120 displays, at step S1118, a Web page 154 contained in the target Web site 152.

As shown in FIG. 11B, the user at the client computer 110 or 120 clicks, at step S1202, an icon of the Web browser 112 or 122 displayed on a computer monitor of the client computer 110 or 120. Then, the Web browser 112 or 122 connects, at step S1204, the client computer 110 or 120 to the intermediate Web site 142 contained in the intermediate server computer 140 over the Internet network 130. Then, the computer monitor of the client computer 110 or 120 displays, at step S1206, the display screen 1000 as a Web page 144 contained in the intermediate Web site 142.

Hereinafter, the user puts, at step S1208, a cursor into an input box for a Korean-based domain name or a Korean keyword. Then, at step S1210, it is determined whether the cursor is put into any input box. If the cursor is put into the input box for the Korean-based domain name, a color of a surrounding portion of the input box for the Korean-based domain name is varied at step S1212. Then, the user inputs, at step S1214, a set of key data corresponding to the Korean-based domain name into the input box for the Korean-based domain name. Then, the Web-site search module 147 identifies, at step S1216, the English-based domain name mapped to the Korean-based domain name. Then, the Web-site search module 146 searches, at step S1218, the target Web site 152 having the English-based domain name. Then, the computer monitor of the client computer 110 or 120 displays, at step S1220, the Web page 154 contained in the target Web site 152.

Otherwise, if the cursor is put into the input box for the Korean keyword, a color of the input box for the Korean keyword is varied at step S1224. Then, the user inputs, at step S1226, a set of key data corresponding to the Korean keyword into the input box for the Korean keyword. Then, the user designates, at step S1228 one class in a list of classes through a designation box. Then, the Web-site search module 147 shown in FIG. 1 identifies, at step S1230, the English-based domain name mapped to the Korean keyword corresponding to the designated class from the DB 148 shown in FIG. 1. Then, the Web-site search module 147 searches, at step S1232, a target Web site 152 having the English-based domain name identified from the DB 148. Then, the computer monitor of the client computer 110 or 120 displays, at step S1220, the Web page 154 contained in the target Web site 152.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A system for searching a Web site, comprising:
a server computer for providing at least one Web page to a client computer, the web page including:
an input box having a first or second language-based domain name inputted by a user at said client computer;
a first keyboard conversion icon being clicked in order to convert a keyboard into a first language-based keyboard, the keyboard being attached to said client computer;
a second keyboard conversion icon being clicked in order to convert the keyboard into a second language-based keyboard; and
a search icon being clicked in order to search the Web site having the first language-based domain name mapped to the second language-based domain name.

2. The system as recited in claim 1, wherein said client computer includes:
a Web browser for connecting said client computer to said server computer through an Internet network.

3. The system as recited in claim 1, wherein said server computer includes:
a first search means for searching the Web site having the first language-based domain name; and
a second search means for searching the Web site having the first language-based domain name mapped to the second language-based domain name.

4. The system as recited in claim 3, wherein said server computer further includes:
a storage means for storing a mapping table, the mapping table including first language-based domain names and second language-based domain names.

5. The system as recited in claim 4, wherein said second search means further includes:
an identifying means for identifying the first language-based domain name mapped to the second language-based domain name from the mapping table.

6. The system as recited in claim 4, wherein the mapping table further includes third language-based domain names.

7. The system as recited in claim 6, wherein said second search means further searches the Web site having the first language-based domain name mapped to a third language-based domain name identified from the mapping table.

8. The system as recited in claim 7, wherein said second search means further includes:
a second identifying means for identifying the first language-based domain name mapped to the third language-based domain name identified from the mapping table.

9. The system as recited in claim 7, wherein the Web page further includes:
a screen keyboard for generating a set of screen key data corresponding to the third language-based domain name.

10. The system as recited in claim 9, wherein the input box further has the third language-based domain name inputted via the screen keyboard by the user at said client computer.

11. The system as recited in claim 1, wherein the first language-based domain name includes an English-based domain name.

12. The system as recited in claim 1, wherein the second language-based domain name includes a Korean-based domain name, a Japanese-based domain name, a Chinese-based domain name, a German-based domain name, a French-based domain name, an Italian-based domain name, a Latin-based domain name, a Russian-based domain name, a Spanish-based domain name, an Arab-based domain name, a Portuguese-based domain name, a Dutch-based domain name and a Hindustani-based domain name.

13. The system as recited in claim 7, wherein the third language-based domain name includes a Korean-based domain name, a Japanese-based domain name, a Chinese-based domain name, a German-based domain name, a French-based domain name, an Italian-based domain name, a Latin-based domain name, a Russian-based domain name, a Spanish-based domain name, an Arab-based domain name, a Portuguese-based domain name, a Dutch-based domain name and a Hindustani-based domain name.

14. The system as recited in claim 3, wherein the mapping table further includes keywords, which are mapped to the first language-based domain name, respectively, and class information related to the keywords.

15. The system as recited in claim 1, wherein the input box further has a keyword inputted by the user.

16. The system as recited in claim 15, wherein the keyword includes a first language keyword and a second language keyword.

17. The system as recited in claim 16, wherein the first language keyword includes an English keyword.

18. The system as recited in claim 16, wherein the second language keyword includes a Korean keyword, a Japanese keyword, a German keyword, a Chinese keyword, a French keyword, an Italian keyword, a Latin keyword, a Russian keyword, a Spanish keyword, an Arab keyword, a Portuguese keyword, a Dutch keyword and a Hindustani keyword.

19. The system as recited in claim 16, wherein the Web page further includes:
a designation box having a list of classes so that the user can designate one class corresponding to the first or second language keyword in the list of classes.

20. The system as recited in claim 19, wherein the list of classes includes a business corporation name, a firm name, a company name, a trademark name, a product name, a private person name, a musician name, an entertainer name, a sportsman name, an artist name, a churchman name, a politician name, a businessman name, a celebrity name, a lawyer name, a school name, a state organization name, a non-profit organization name, an institute name, a network manager name, etc.

21. The system as recited in claim 9, wherein said server computer further includes:
a display means for displaying the screen keyboard on a computer monitor of said client computer; and
a conversion means for converting the screen keyboard based on a language to that based on another language.

22. The system as recited in claim 21, wherein said conversion means converts the screen keyboard based on an English language to that based on a Korean language.

23. The system as recited in claim 1, wherein a color of the first or second keyboard conversion icon is varied if the user at said client computer clicks the first or second keyboard conversion icon.

24. The system as recited in claim 1, wherein the Web page further includes:
a designation box having a list of countries so that the user can designate one country in the list of countries.

25. The system as recited in claim 24, wherein said second search means connects said client computer to the Web site corresponding to the designated country if the user designates one country in the list of countries.

26. The system as recited in claim 1, wherein another Web page provided by said server computer includes:
a first input box having the first language-based domain name or a first language keyword inputted by the user at said client computer; and
a second input box having the second language-based domain name or a second language keyword inputted by the user at said client computer.

27. The system as recited in claim 26, wherein said server computer includes:
a conversion means for converting the first language-based keyboard into the second language-based keyboard.

28. The system as recited in claim 27, wherein said conversion means further converts the second language-based keyboard into the first language-based keyboard.

29. The system as recited in claim 28, wherein the second language-based keyboard is converted into the first language-based keyboard by said conversion means if a cursor on a monitor of said client computer is put into the first input box.

30. The system as recited in claim 27, wherein the first language-based keyboard is converted into the second language-based keyboard by said conversion means if a cursor on a monitor of said client computer is put into the second input box.

31. A system for searching a target Web site, comprising:
an Internet network;
a client computer, coupled to said Internet network, for displaying at least one target Web page contained in the target Web site;
an intermediate server computer, coupled to said Internet network, for providing at least one intermediate Web page to said client computer, the intermediate Web page including:
an input box having a first or second language-based domain name inputted by a user at said client computer;
a first keyboard conversion icon being clicked in order to convert a keyboard into a first language-based keyboard, the keyboard being attached to said client computer;
a second keyboard conversion icon being clicked in order to convert the keyboard into a second language-based keyboard; and
a search icon being clicked in order to search the target Web site having the first language-based domain name mapped to the second language-based domain name; and
a target server computer, coupled to said Internet network, for providing the target Web page targeted by said client computer.

32. The system as recited in claim 31, wherein said client computer includes:
a Web browser for connecting said client computer to said intermediate server computer through said Internet network.

33. The system as recited in claim 31, wherein said intermediate server computer includes:
a first search means for searching the target Web site having the first language-based domain name; and
a second search means for searching the target Web site having the first language-based domain name mapped to the second language-based domain name.

34. The system as recited in claim 33, wherein said intermediate server computer further includes:
a storage means for storing a mapping table, the mapping table including first language-based domain names and second language-based domain names.

35. The system as recited in claim 34, wherein said second search means further includes:
an identifying means for identifying the first language-based domain name mapped to the second language-based domain name from the mapping table.

36. The system as recited in claim 34, wherein the mapping table further includes third language-based domain names.

37. The system as recited in claim 36, wherein said second search means further searches the Web site having the first language-based domain name mapped to a third language-based domain name identified from the mapping table.

38. The system as recited in claim 37, wherein said second search means further includes:
a second identifying means for identifying the first language-based domain name mapped to the third language-based domain name from the mapping table.

39. The system as recited in claim 37, wherein the intermediate Web page further includes:
a screen keyboard for generating a set of screen key data corresponding to the third language-based domain name.

40. The system as recited in claim 39, wherein the input box further has the third language-based domain name inputted via the screen keyboard by the user at said client computer.

41. The system as recited in claim 31, wherein the first language-based domain name includes an English-based domain name.

42. The system as recited in claim 31, wherein the second language-based domain name includes a Korean-based domain name, a Japanese-based domain name, a Chinese-based domain name, a German-based domain name, a French-based domain name, an Italian-based domain name, a Latin-based domain name, a Russian-based domain name, a Spanish-based domain name, an Arab-based domain name, a Portuguese-based domain name, a Dutch-based domain name and a Hindustani-based domain name.

43. The system as recited in claim 37, wherein the third language-based domain name includes the Korean-based domain name, the Japanese-based domain name, the Chinese-based domain name, the German-based domain name, a French-based domain name, an Italian-based domain name, a Latin-based domain name, a Russian-based domain name, a Spanish-based domain name, an Arab-based domain name, a Portuguese-based domain name, a Dutch-based domain name and a Hindustani-based domain name.

44. The system as recited in claim 34, wherein the mapping table further includes keywords, which are mapped to the first language-based domain name, respectively, and class information related to the keywords.

45. The system as recited in claim 31, wherein the input box further has a keyword inputted by the user.

46. The system as recited in claim 45, wherein the keyword includes a first language keyword and a second language keyword.

47. The system as recited in claim 46, wherein the first language keyword includes an English keyword.

48. The system as recited in claim 46, wherein the second language keyword includes a Korean keyword, a Japanese keyword, a German keyword, a Chinese keyword, a French keyword, an Italian keyword, a Latin keyword, a Russian keyword, a Spanish keyword, an Arab keyword, a Portuguese keyword, a Dutch keyword and a Hindustani keyword.

49. The system as recited in claim 46, wherein the intermediate Web page further includes:
a designation box having a list of classes so that the user can designate one class corresponding to the first or second language keyword in the list of classes.

50. The system as recited in claim 49, wherein the list of classes includes a business corporation name, a firm name, a company name, a private person name, a musician name, an entertainer name, a sportsman name, an artist name, a churchman name, a politician name, a businessman name, a celebrity name, a lawyer name, a school name, a state organization name, a non-profit organization name, an institute name, a network manager name, etc.

51. The system as recited in claim 39, wherein said intermediate server computer further includes:
a display means for displaying the screen keyboard on a computer monitor of said client computer; and
a conversion means for converting the screen keyboard based on a language to that based on another language.

52. The system as recited in claim 51, wherein said conversion means converts the screen keyboard based on an English language to that based on a Korean language.

53. The system as recited in claim 31, wherein a color of the first or second keyboard conversion icon is varied if the user at said client computer clicks the first or second keyboard conversion icon.

54. The system as recited in claim 31, wherein the intermediate Web page further includes:
a designation box having a list of countries so that the user can designate one country in the list of countries.

55. The system as recited in claim 54, wherein said second search means connects said client computer to the target Web site corresponding to the designated country if the user designates one country in the list of countries.

56. The system as recited in claim 31, wherein another intermediate Web page provided by said intermediate server computer includes:
a first input box having the first language-based domain name or a first language keyword inputted by the user at said client computer; and
a second input box having the second language-based domain name or a second language keyword inputted by the user at said client computer.

57. The system as recited in claim 56, wherein said intermediate server computer includes:
a conversion means for converting the first language-based keyboard into the second language-based keyboard.

58. The system as recited in claim 57, wherein said conversion means further converts the second language-based keyboard into the first language-based keyboard.

59. The system as recited in claim 58, wherein the second language-based keyboard is converted into the first language-based keyboard by said conversion means if a cursor on a monitor of said client computer is put into the first input box.

60. The system as recited in claim 57, wherein the first language-based keyboard is converted into the second language-based keyboard by said conversion means if a cursor on a monitor of said client computer is put into the second input box.

61. A method for searching a target Web site, comprising the steps of:
a) inputting a set of key data corresponding to a domain name, the domain name including a first language-based domain name and a second language-based domain name;
b) identifying the first language-based domain name mapped to the second language-based domain name from a mapping table; and
c) searching the target Web site having the first language-based domain name identified from the mapping table.

62. The method as recited in claim 61, wherein said step a) includes the steps of:
a1) clicking an icon of a Web browser to connect a client computer to an intermediate server computer;
a2) displaying at least one intermediate Web page on a computer monitor of the client computer;
a3) inputting the set of key data corresponding to the domain name; and
a4) determining the domain name inputted.

63. The method as recited in claim 62, wherein the intermediate Web page includes:
an input box having the first or second language-based domain name as the set of key data inputted by a user at the client computer;
a first keyboard conversion icon being clicked in order to convert a keyboard into a first language-based keyboard, the keyboard being attached to the client computer;
a second keyboard conversion icon being clicked in order to convert the keyboard into a second language-based keyboard; and
a search icon being clicked in order to search the target Web site having the first language-based domain name mapped to the second language-based domain name.

64. The method as recited in claim 62, wherein said step b) includes the steps of:
b1) if the domain name inputted is the first language-based domain name, searching the target Web site having the first language-based domain name; and
b2) if the domain name inputted is the second language-based domain name, identifying the first language-based domain name mapped to the second language-based domain name from the mapping table.

65. The method as recited in claim 61, wherein the first language-based domain name includes an English-based domain name.

66. The method as recited in claim 61, wherein the second language-based domain name includes a Korean-based domain name, a Japanese-based domain name, a Chinese-based domain name, a German-based domain name, a French-based domain name, an Italian-based domain name, a Latin-based domain name, a Russian-based domain name, a Spanish-based domain name, an Arab-based domain name, a Portuguese-based domain name, a Dutch-based domain name and a Hindustani-based domain name.

67. The method as recited in claim 62, wherein the intermediate Web page further includes:
a screen keyboard for generating a set of screen key data corresponding to a third language-based domain name.

68. The method as recited in claim 67, further comprising the step of:
d) identifying the first language-based domain name mapped to the third language-based domain name from the mapping table.

69. The method as recited in claim 68, further comprising the step of:
e) searching the target Web site having the first language-based domain name mapped to the third language-based domain name identified from the mapping table.

70. The method as recited in claim 67, wherein the input box further has the third language-based domain name inputted via the screen keyboard by the user at the client computer.

71. The method as recited in claim 67, wherein the third language-based domain name includes the Korean-based domain name, the Japanese-based domain name, the Chinese-based domain name, the German-based domain name, a French-based domain name, an Italian-based domain name, a Latin-based domain name, a Russian-based domain name, a Spanish-based domain name, an Arab-based domain name, a Portuguese-based domain name, a Dutch-based domain name and a Hindustani-based domain name.

72. The method as recited in claim 61, wherein the mapping table further includes keywords, which are mapped to the first language-based domain name, respectively, and class information related to the keywords.

73. The method as recited in claim 63, wherein the input box further has a keyword inputted by the user.

74. The method as recited in claim 73, wherein the keyword includes a first language keyword and a second language keyword.

75. The method as recited in claim 74, wherein the first language keyword includes an English keyword.

76. The method as recited in claim 74, wherein the second language keyword includes a Korean keyword, a Japanese keyword, a German keyword, a Chinese keyword, a French keyword, an Italian keyword, a Latin keyword, a Russian keyword, a Spanish keyword, an Arab keyword, a Portuguese keyword, a Dutch keyword and a Hindustani keyword.

77. The method as recited in claim 74, wherein said intermediate Web page further includes a designation box having a list of classes so that the user can designate one class corresponding to the first or second language keyword in the list of classes.

78. The method as recited in claim 77, wherein the list of classes includes a business corporation name, a firm name, a company name, a trademark name, a product name, a private person name, a musician name, an entertainer name, a sportsman name, an artist name, a churchman name, a politician name, a businessman name, a celebrity name, a lawyer name, a school name, a state organization name, a non-profit organization name, an institute name, a network manager name, etc.

79. The method as recited in claim 63, wherein a color of the first or second keyboard conversion icon is varied if the user at the client computer clicks the first or second keyboard conversion icon.

80. The method as recited in claim 69, wherein the intermediate Web page further includes:
a designation box having a list of countries so that the user can designate one country in the list of countries.

81. The method as recited in claim 80, wherein said step e) further includes the step of:
connecting the client computer to the target Web site corresponding to the designated country if the user designates one country in the list of countries.

82. The method as recited in claim 62, wherein the intermediate Web page includes:
a first input box having the first language-based domain name or a first language keyword inputted by the user at the client computer; and
a second input box having the second language-based domain name or a second language keyword inputted by the user at the client computer.

83. The method as recited in claim 82, further comprising the step of:
f) converting the first language-based keyboard into the second language-based keyboard.

84. The method as recited in claim 83, further comprising the step of:
g) converting the second language-based keyboard into the first language-based keyboard.

85. The method as recited in claim 84, wherein the second language-based keyboard is converted into the first language-based keyboard if a cursor on a monitor of the client computer is put into the first input box.

86. The method as recited in claim 83, wherein the first language-based keyboard is converted into the second language-based keyboard if a cursor on a monitor of the client computer is put into the second input box.

87. A computer-readable medium storing program instructions, the program instructions disposed on a computer to perform a method for searching a target Web site, the method comprising the steps of:
a) inputting a set of key data corresponding to a domain name, the domain name including a first language-based domain name and a second language-based domain name;
b) identifying the first language-based domain name mapped to the second language-based domain name from a mapping table; and
c) searching the target Web site having the first language-based domain name identified from the mapping table.

88. The computer-readable medium as recited in claim 87, wherein said step a) includes the steps of:
a1) clicking an icon of a Web browser to connect a client computer to an intermediate server computer;
a2) displaying at least one intermediate Web page on a computer monitor of the client computer;
a3) inputting the set of key data corresponding to the domain name; and
a4) determining the domain name inputted.

89. The computer-readable medium as recited in claim 88, wherein the intermediate Web page includes:
an input box having the first or second language-based domain name as the set of key data inputted by a user at the client computer;
a first keyboard conversion icon being clicked in order to convert a keyboard into a first language-based keyboard, the keyboard being attached to the client computer;
a second keyboard conversion icon being clicked in order to convert the keyboard into a second language-based keyboard; and
a search icon being clicked in order to search the target Web site having the first language-based domain name mapped to the second language-based domain name.

90. The computer-readable medium as recited in claim 88, wherein said step b) includes the steps of:
b1) if the domain name inputted is the first language-based domain name, searching the target Web site having the first language-based domain name; and
b2) if the domain name inputted is the second language-based domain name, identifying the first language-based domain name mapped to the second language-based domain name from the mapping table.

91. The computer-readable medium as recited in claim 89, wherein the first language-based domain name includes an English-based domain name.

92. The computer-readable medium as recited in claim 89, wherein the second language-based domain name includes a Korean-based domain name, a Japanese-based domain name, a Chinese-based domain name, a German-based domain name, a French-based domain name, an Italian-based domain name, a Latin-based domain name, a Russian-based domain name, a Spanish-based domain name, an Arab-based domain name, a Portuguese-based domain name, a Dutch-based domain name and a Hindustani-based domain name.

93. The computer-readable medium as recited in claim 88, wherein the intermediate Web page further includes:
a screen keyboard for generating a set of screen key data corresponding to a third language-based domain name.

94. The computer-readable medium as recited in claim 93, further comprising the step of:
d) identifying the first language-based domain name mapped to the third language-based domain name from the mapping table.

95. The computer-readable medium as recited in claim 94, further comprising the step of:
e) searching the target Web site having the first language-based domain name mapped to the third language-based domain name identified from the mapping table.

96. The computer-readable medium as recited in claim 93, wherein the input box further has the third language-based domain name inputted via the screen keyboard by the user at the client computer.

97. The computer-readable medium as recited in claim 93, wherein the third language-based domain name includes the Korean-based domain name, the Japanese-based domain name, the Chinese-based domain name, the German-based domain name, a French-based domain name, an Italian-based domain name, a Latin-based domain name, a Russian-based domain name, a Spanish-based domain name, an Arab-based domain name, a Portuguese-based domain name, a Dutch-based domain name and a Hindustani-based domain name.

98. The computer-readable medium as recited in claim 87, wherein the mapping table further includes keywords, which are mapped to the first language-based domain name, respectively, and class information related to the keywords.

99. The computer-readable medium as recited in claim 89, wherein the input box further has a keyword inputted by the user.

100. The computer-readable medium as recited in claim 99, wherein the keyword includes a first language keyword and a second language keyword.

101. The computer-readable medium as recited in claim 100, wherein the first language keyword includes an English keyword.

102. The computer-readable medium as recited in claim 100, wherein the second language keyword includes a Korean keyword, a Japanese keyword, a German keyword, a Chinese keyword, a French keyword, an Italian keyword, a Latin keyword, a Russian keyword, a Spanish keyword, an Arab keyword, a Portuguese keyword, a Dutch keyword and a Hindustani keyword.

103. The computer-readable medium as recited in claim 100, wherein said intermediate Web page further includes a designation box having a list of classes so that the user can designate one class corresponding to the first or second language keyword in the list of classes.

104. The computer-readable medium as recited in claim 103, wherein the list of classes includes a business corporation name, a firm name, a company name, a trademark name, a product name, a private person name, a musician name, an entertainer name, a sportsman name, an artist name, a churchman name, a politician name, a businessman name, a celebrity name, a lawyer name, a school name, a state organization name, a non-profit organization name, an institute name, a network manager name, etc.

105. The computer-readable medium as recited in claim 89, wherein a color of the first or second keyboard conversion icon is varied if the user at the client computer clicks the first or second keyboard conversion icon.

106. The computer-readable medium as recited in claim 95, wherein the intermediate Web page further includes:
a designation box having a list of countries so that the user can designate one country in the list of countries.

107. The computer-readable medium as recited in claim 106, wherein said step e) further includes the step of:
connecting the client computer to the target Web site corresponding to the designated country if the user designates one country in the list of countries.

108. The computer-readable medium as recited in claim 88, wherein the intermediate Web page includes:
a first input box having the first language-based domain name or a first language keyword inputted by the user at the client computer; and
a second input box having the second language-based domain name or a second language keyword inputted by the user at the client computer.

109. The computer-readable medium as recited in claim 108, further comprising the step of:
f) converting the first language-based keyboard into the second language-based keyboard.

110. The computer-readable medium as recited in claim 109, further comprising the step of:
g) converting the second language-based keyboard into the first language-based keyboard.

111. The computer-readable medium as recited in claim 110, wherein the second language-based keyboard is converted into the first language-based keyboard if a cursor on a monitor of the client computer is put into the first input box.

112. The computer-readable medium as recited in claim 109, wherein the first language-based keyboard is converted into the second language-based keyboard if a cursor on a monitor of the client computer is put into the second input box.
